(19) United States
(12) Patent Application Publication
(10) Pub. No.: US 2014/0196835 A1
(43) Pub. Date: Jul. 17, 2014

(54) METHOD FOR PRODUCING MOLDED PRODUCTS USING COFFEE GROUNDS

(71) Applicant: Byeong Geol Lim, Anyang-si (KR)

(72) Inventor: Byeong Geol Lim, Anyang-si (KR)

(21) Appl. No.: 14/239,338

(22) PCT Filed: Aug. 31, 2011
(86) PCT No.: PCT/KR2012/006967

§ 371 Date: Feb. 18, 2014

(30) Foreign Application Priority Data
Sep. 1, 2011 (KR) 10-2011-0088444

(51) Int. Cl. B29C 67/24; B29C 65/00

(52) U.S. Cl. CPC B29C 67/24; B29C 65/002
USPC 156/153; 264/162

(57) ABSTRACT

A method for producing molded products using coffee grounds in which coffee grounds are collected from coffee shop and then dried, fractioned, and ground, after which the thus-processed coffee grounds are mixed with purified water and binding agent, and the resultant mixture is poured into a mold to be compression molded into various shapes, e.g. cubes. The thus-molded articles may replace existing soaps used for practicing carving so as to prevent wasted resources and environmental contamination. The method for producing molded products using coffee grounds according to the present invention enables a minimal addition of chemicals during molding so as to provide practice materials which are harmless to the human body.

### BACKGROUND

The present invention relates to a method for producing molded products using coffee grounds, and in particular to a method for producing molded products using coffee grounds which comprises collecting coffee grounds which were usually discarded, drying, sorting by granules and grinding, and the processed coffee grounds are mixed with purified water and a binding agent, and the mixed mixture is molded into a certain shape using a mold.

Most of elementary schools in Korea have carving classes using soaps, and it is known that about 150 thousand soaps are consumed per year for the carving classes of the elementary schools. After the classes are finished, the carved particles of the soaps are discarded, which causes over consumption and environmental contaminations. In case of the carving classes which use soaps with a lot of chemical components, the contained chemical components may hurt the human body, so the developments of environmentally friendly class materials are urgently required.

In order to improve the above described problems, the coffee grounds which were generally discarded are collected and molded in a certain shape and can be used for carving classes.

It is known that the Korean Coffee Market Share is 1,900,000,000,000 won, and the Korea markets imported about 100,000 tons of beans in 2009, more specifically, 96,000 tons of green beans, and 3,500 tons of dried beans. The total quantity of the coffee grounds which are leftovers are 100,000 tons. There were a few trials of using the coffee grounds as deodorizers or animal feeds; however such trials were failed because the demand for recycled products was low, and the processes were complicate, and their applicability was low.

To improve the above mentioned problems, the coffee grounds are collected from coffee shops, and the collected coffee grounds are processed via a dry-sorting-driving procedure, and the thusly processed coffee grounds are mixed with purified water and a binding agent and are inputted in a fixing mold and are compressed and molded in various shapes such as cubes, which can substitute the soaps which were generally used for carving classes of the school, so it is possible to prevent over consumption of resources and environmental contaminations. Since the addition of chemical components is minimal, a material for school class which is not harmful to the human body can be provided.

### SUMMARY OF THE INVENTION

Accordingly, it is an object of the present invention provide an environmentally friendly school class material.

It is another object of the present invention to provide a method for producing molded products using coffee grounds which makes it possible to prepare various shapes of molded products such as cubes via multiple processes and using a mixture and a binding agent so as to manufacture a molded product using coffee grounds.

It is further another object of the present invention to provide a method for producing molded products using coffee grounds in which small cubes are made using coffee grounds which were processed via multiple procedures, and a small cube is adhered to an angled surface of another small cube, thus forming a large cube, and the small cubes are removed based on the manual for thereby forming a certain shape.

To achieve the above objects, there is provided a method for producing molded products using coffee grounds in which coffee grounds are collected from a coffee shop, and the collected coffee grounds are processed via a dry-sorting-grinding procedure, and the processed coffee grounds are mixed with purified water and a binding agent and are inputted in a fixed mold for thereby molding various shapes of cubes.

To achieve the above objects, there is provided a method for producing molded products using coffee grounds in which small cubes are manufactured via the above mentioned method and are colored, and each cube is numbered, and a small cube is attached to an angled surface of another small cube for hereby forming a large cube, and the cubes assigned with numbers and belonging to the large cube are removed based on the manual for thereby forming a certain shape with multiple colors.

The present invention is directed to a method for producing molded products using coffee grounds which is environmentally friendly because the students of elementary schools use the recycled, molded products prepared using coffee grounds instead of using soaps in their classes.

In addition, according to the present invention, since the coffee grounds are molded using the powder which is sterilized at above 100° C., the molded products have deodorizing effects of coffee grounds before they are processed, and keratin removing effects and sterilization effects and are good for the health of people.

### BRIEF DESCRIPTION OF DRAWINGS

FIG. 1 is a flow chart of a method for producing a molded product using coffee grounds according to the present invention.

FIG. 2 is a flow chart of a method for producing a large cube in such a way to produce a molded product of a cube shape using coffee grounds and to bind them.

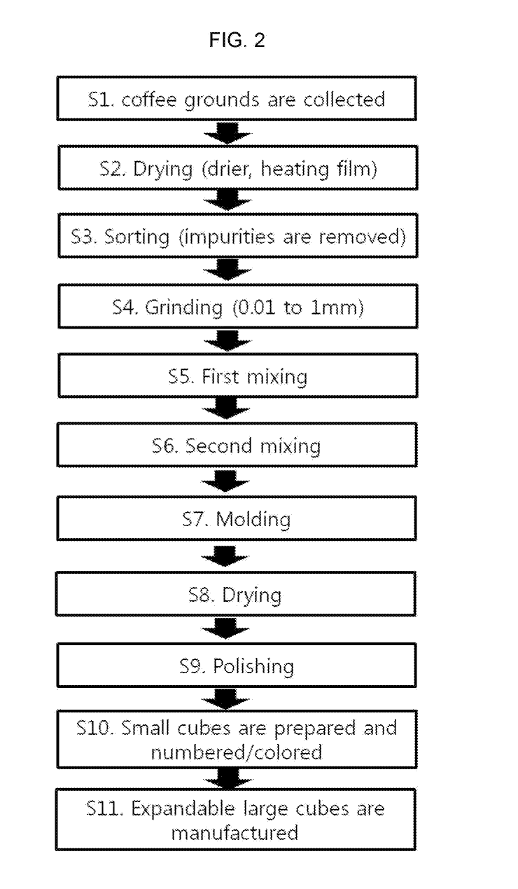

### DETAILED DESCRIPTION OF THE INVENTION

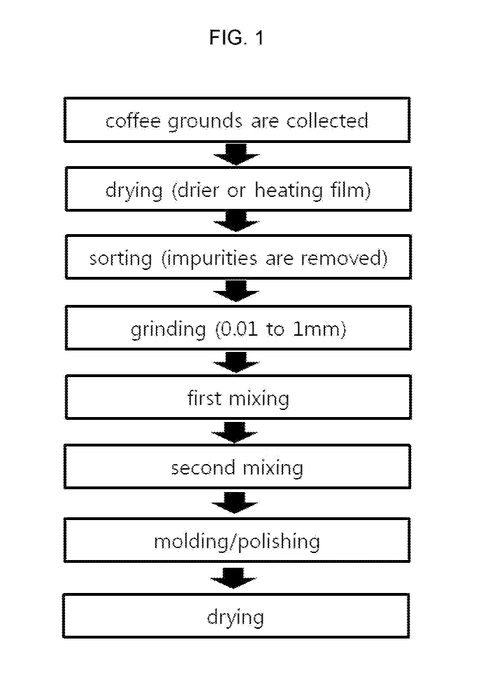

The present invention is directed to a method for producing molded products using coffee grounds. As shown in FIG. 1, the method for producing molded products using coffee grounds according to the present invention comprises a step for collecting coffee grounds from a coffee shop; a dry step for drying the collected coffee grounds using a drier and a heating film at higher than 15° C.; a step for sorting the granules of the coffee grounds so as to remove impurities; a step for grinding the sorted granules; a first mixing step for mixing the ground powders with a fixing agent or a binding agent and pasting the same; a second mixing step for mixing the mixture of the first mixing step with purified water and pasting the same; a step for inputting the mixture in a mold and compressing and molding the mixture; a dry step for drying the molded article; and a polishing step for polishing the molded article.

More specifically, the coffee grounds containing more or less than 20% of moisture are collected from the coffee shops, and the collected coffee grounds are dried using a drier or a heating film at higher than 15° C. When less than 0.1 g of an additive is added per 1 g of the coffee grounds, the molded article is separated due to a low viscosity, and in case of more than 0.5 g per 1 g, much more additives are required, so the effects of the coffee grounds may be lost. For this reason, the impurities contained in the coffee grounds are removed via the sorting step. In the first mixing step, the binding agent formed of HPC (Hydroxyrpopyl cellulose), HPC-L, CMC-NA (Carboxymethyl celluose sodium), progelatinized starch, Xanthan gum, Povidone, HPMC (Hydroxypropyl methyl cellulose), PVP (Poly vinyl pyrrolidone), sodium silicate, K₂SiO₃, dextrin Arabia rubber, formaldehyde, vitrified, silicate, shellac, rubber, resinoid, bakelite, rubber, silicate shellac magnesite, agar powder or starch is added in a range of 0.01 to 0.5 g per 1 g of the coffee grounds which is each sized less than 0.01 to 1 mm and has less than 20% of moisture after impurities are removed. In the second mixing step, less than 1 mL of purified water is added per 1 g of the mixture produced via the first mixing step and is pasted. The mixture of the second mixing step is inputted in the mold and is compressed and molded. When the coffee grounds are dried at below 5° C., bacteria or fungus may grow, and in case of higher than 110° C., a cracking phenomenon may occur in the molded products. So, it needs to harden the molded products of the coffee grounds using a drier which is set to a range of 5 to 110° C. so as to dry the molded products.

The molded products of the coffee grounds prepared according to the above described method are manufactured in small cube shapes and are colored, and each small cube is numbered, and a small cube is adhered to an angled surface of another cube for thereby forming a large cube which is expandable, and the small cubes with numbers are sequentially removed based on the manual for thereby forming a certain shape of the molded product.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A method for producing molded products using coffee grounds, comprising:
(S1) a step for collecting coffee grounds from coffee shops;
(S2) a step for drying the collected coffee grounds using a drier or a heating film of higher than 15° C.;
(S3) a step for sorting granular of coffee grounds so as to remove impurities;
(S4) a step for grinding the sorted granular into a size of 0.01 mm to 1 mm;
(S5) a first mixing step in which one or two binding agents of HPC (Hydroxyrpopyl cellulose), HPC-L, CMC-NA (Carboxymethyl celluose sodium), progelatinized starch, Xanthan gum, Povidone, HPMC (Hydroxypropyl methyl cellulose), PVP (Poly vinyl pyrrolidone), sodium silicate, K₂SiO₃, dextrin Arabia rubber, formaldehyde, vitrified, silicate, shellac, rubber, resinoid, bakelite, rubber, silicate shellac magnesite, and agar powder or starch is added to the ground powder, and 0.01 to 0.5 of the mixture is added and mixed per 1 g of the coffee grounds containing more or less than 20% of moisture and is mixed and pasted;
(S6) a second mixing step for mixing purified water with the mixture produced in the first mixing step and for pasting the mixture;
(S7) a step for producing a molded article by compressing and molding by inputting the mixture in a mold;
(S8) a dry step for drying the molded article which was compressed and molded; and
(S9) a polishing step for polishing the molded product using a polishing agent.

2. The method of claim 1, further comprising:
(S10) a step for manufacturing in a small cube shape the molded product of the coffee grounds prepared using the polishing agent and coloring and numbering the small cubes; and
(S11) a step for forming an expandable large cube in such a way to adhere the small cubes of the same sizes to the angled surfaces of the small cubes.

3. The method of claim 1, wherein in the second mixing step in which the mixture produced in the first mixing step is mixed with purified water and is pasted, more or less than 1 mL of purified water is mixed per 1 g of the first mixture produced in the first mixing step.

4. The method of claim 1, wherein in the drying step in which the molded article produced in the second compression and molding is dried, the molded article produced by inputting the second mixture into a mold and compressing and molding the same is dried at a temperature of 5 to 110° C., the second mixture being produced by mixing 1 mL of purified water per 1 g of the first mixture which is produced by adding at least one binding agent formed of HPC (Hydroxyrpopyl cellulose), HPC-L, CMC-NA (Carboxymethyl celluose sodium), progelatinized starch, Xanthan gum, Povidone, HPMC (Hydroxypropyl methyl cellulose), PVP (Poly vinyl pyrrolidone), sodium silicate, K₂SiO₃, dextrin Arabia rubber, formaldehyde, vitrified, silicate, shellac, rubber, resinoid, bakelite, rubber, silicate shellac magnesite, agar powder or starch which component is added by 0.01 to 0.5 g per 1 g of the coffee grounds in the second mixing step in which purified water is mixed with the mixture produced in the first mixing step.

5. The method of claim 2, wherein in the second mixing step in which the mixture produced in the first mixing step is mixed with purified water and is pasted, more or less than 1 mL of purified water is mixed per 1 g of the first mixture produced in the first mixing step.

6. The method of claim 2, wherein in the drying step in which the molded article produced in the second compression and molding is dried, the molded article produced by inputting the second mixture into a mold and compressing and molding the same is dried at a temperature of 5 to 110° C., the second mixture being produced by mixing 1 mL of purified water per 1 g of the first mixture which is produced by adding at least one binding agent formed of HPC (Hydroxyrpopyl cellulose), HPC-L, CMC-NA (Carboxymethyl celluose sodium), progelatinized starch, Xanthan gum, Povidone, HPMC (Hydroxypropyl methyl cellulose), PVP (Poly vinyl pyrrolidone), sodium silicate, K₂SiO₃, dextrin Arabia rubber, formaldehyde, vitrified, silicate, shellac, rubber, resinoid, bakelite, rubber, silicate shellac magnesite, agar powder or starch which component is added by 0.01 to 0.5 g per 1 g of the coffee grounds in the second mixing step in which purified water is mixed with the mixture produced in the first mixing step.
